(19) United States
(12) Patent Application Publication
(10) Pub. No.: US 2001/0023641 A1
(43) Pub. Date: Sep. 27, 2001

(54) Grilling device for a cooking appliance

(76) Inventor: Jurgen Borner, Landscheid-Niederkail (DE)

Correspondence Address: WILLIAM ANTHONY DRUCKER, Attorney at law, 1299 Pennsylvania Avenue, N.W., Washington, DC, 20004-2400, US

(21) Appl. No.: 09/738,762

(22) Filed: Dec. 18, 2000

(30) Foreign Application Priority Data
Dec. 18, 1999 (DE) 299 22 255.1
Feb. 17, 2000 (DE) 100 07 283.6

(51) Int. Cl. A47J 27/00

(52) U.S. Cl. 99/446

(57) ABSTRACT

A grilling device for a cooking appliance, with an underside and a top side upon which a foodstuff to be cooked can be laid, wherein the top side comprises a plurality of raised portions upon which the foodstuff can be laid and a plurality of depressions in which liquid can be received, wherein at least some of the depressions are troughs which are inclined with respect to the underside, and wherein a cross-trough is provided at the top side, serving as a collection container into which the troughs lead (FIG. 14).

### BACKGROUND OF THE INVENTION

1. Field of the Invention

The present invention relates to a grilling device for a cooking appliance, with an underside and a top side upon which a foodstuff to be cooked can be laid, wherein the top side comprises a plurality of raised portions upon which the foodstuff can be laid and a plurality of depressions in which liquid can be received.

Such grilling devices for cooking appliances are well known, particularly in the shape of so-called drip pans made of aluminum.

A cooking appliance is, in the present context, to be understood a classical heat source like a stove heating plate, a charcoal grill, a gas grill, etc. However, a cooking appliance is, in the present context, also to be understood as a cooking device like a frying pan, a cooking pot, or similar devices.

Foodstuff to be cooked is, in the present context, to be understood as food that can be cooked by frying or grilling, like meat, fish, vegetables, etc.

2. Description of the Related Art

The aluminum drip pans mentioned at the outset are made of a thin aluminum foil or aluminum sheet material and are throwaway products. Usually, the drip pan comprises an upstanding circumferential edge and a floor area that is provided with raised portions, wherein the floor area is, optionally, provided with holes that are located in the proximity of raised portions. By means of the holes, grilling steam can act directly upon the foodstuff to be cooked.

On the one hand, those drip pans have the disadvantage that the heat transfer onto the foodstuff to be cooked is not always uniform. This is, to one part, due to the holes, to the other part due to the relative high raised portions in the wave-shaped floor area. The comparatively high raised portions are to prevent that fluid exuding from the foodstuff to be cooked, floods the floor of the drip pan. Namely, this would have the consequence that the foodstuff to be cooked simmers in its own drippings and is not grilled. On the other hand, such drip pans can only be used for grilling purposes, and cannot be used for other purposes within a household.

U.S. Pat. No. 3,842,726 discloses a gas grill for professional use. The grill comprises several gas burners located within a housing made of sheet metal. A relatively thick plate made of cast iron is arranged above the gas burners. The plate is provided, at its top side, with longitudinal troughs, and is on a whole arranged under an angle of approximately 5° with respect to the horizontal. Liquid exuding from the foodstuff to be grilled or cooked, flows off from the plate and is received within a collection reservoir of the sheet metal housing. The depths of the troughs increases continuously from the highest point of the plate in flowing direction of the fluid. The plate comprises depressions at its underside, wherein heat sensors are attached within the depressions using corresponding clips. The plate can be detached only together with a part of the sheet frame, and cannot be used for other purposes.

Further, U.S. Pat. No. 5,606,905 discloses an electrical grill which comprises a lower grilling plate, and an upper grilling plage hingedly connected thereto like a waffle iron, wherein a foodstuff to be grilled like a hamburger can be included between those plates. The lower grilling plate is arranged under an angle with respect to the horizontal and comprises a plurality of ridges which extend in a curved shape upwardly and which prevent that the foodstuff to be cooked slips off from the inclined lower grilling plate while allowing exuding juices to obliquely flow off. The exuding juices are either guided through an opening into a separate collecting container, or are guided into a collection container that is shaped integrally with the lower grilling plate.

The grilling plates are each provided with electrical heating elements.

Document DE 35 05 630 C1 discloses a cover for frying and cooking devices. The cover comprises a metal annular part which can be placed upon the upstanding edge of different cooking devices, particularly frying pans. A glass hood can be placed within the metal annular part, which hood has a conical shape. The glass hood comprises a central opening and a grip so as to allow handling of the cover in combination with the metal annular part.

The cover is particularly suitable for use when frying meat. To this purpose, the cover is placed upon a frying pan in which the meat is fried. The hood prevents that fat spatters onto the stove. Steam can exit via the opening in the glass hood.

Frying pans generally have a flat underside, so that they can be employed on electric stove heating plates or ceramic heating plates as well as on a gas burner. The floor of the frying pan upon which food is cooked is also flat. Fat (oil, butter, etc.) placed in the pan before frying therefore is well distributed.

Cooking foods in fat such as meat, fish, vegetables, etc. has the advantage that the food does not “burn” so rapidly, however, the particular taste of the food is often lost. For this reason, grilling is often preferred over frying. In the present application, the term grilling will be understood essentially as the application of intensive heat to the food but without liquids, in particular without fat or the like.

As mentioned, the conventional frying pan is very unsuitable for grilling, because the food to be fried (actually to be grilled) often burns without the addition of fat. In addition, liquids exude from the food during the process, so that the food “simmers in its own drippings”, however, it is not grilled. Thus even frying pans with anti-friction coatings are not suited for grilling. Special electrical appliances are often used for grilling (cf. the above-mentioned U.S. Pat. No. 5,606,905), which normally, however, are designed for use on the dinner table, but not for cooking in the kitchen. In addition, such appliances are expensive and require storage space when not in use.

### SUMMARY OF THE INVENTION

The object of the present invention is therefore to provide an improved appliance for frying or grilling.

According to a first aspect of the present invention, the above object is achieved by a grilling device for a cooking appliance, as mentioned at the outset, wherein at least some of the depressions are troughs which are inclined with respect to the underside, and wherein a cross-trough is provided at the top side, serving as a collection container into which the troughs lead.

According to a second aspect of the present invention, the above object is achieved by a grilling device for a cooking appliance, as mentioned at the outset, wherein the underside of the grilling device is formed to be substantially flat.

In the grilling device according to the first aspect of the invention, the troughs can each be comparatively shallow because the troughs are inclined and because a cross-trough is provided at the top side, serving as a collection container. Namely, because of the inclination exuding fluids do not accumulate within the troughs. The substantially shallow shape of the troughs facilitates a uniform heat transfer onto the food to be cooked. The fluid exuding from the food to be cooked, flows off via the troughs into the collection container. Thus, the underside of the food to be cooked remains fully or substantially dry. Thereby, food to be cooked can be grilled with the grilling device according to the first aspect of the invention. The inherent taste of the food to be cooked can be preserved.

The grilling device according to the second aspect of the invention is particularly universal, in view of the underside which is formed to be substantially flat. On the one hand, the grilling device can be placed upon any type of well-known heat sources, e.g. a heating plate or a charcoal grill or a gas grill. On the other hand, the grilling device can be placed upon the floor of a frying device, e.g. a frying pan, provided that the grilling device is suitably shaped. The food to be cooked is placed upon the top side of the grilling device, e.g. a piece of meat, fish, vegetables, etc. Heat is transferred from the frying device onto the grilling device, whereupon the food to be cooked is heated. In case of a flat underside, when using the grilling device on the floor of a frying device, a large contact area is established and, thus, a good heat transfer.

In order to improve the heat transfer between the floor of the frying device and the underside of the grilling device, it might be useful to moisten the floor of the frying device with a fat, e.g. frying fat, oil, etc. It is to be understood that this should be made only to a height below the top side of the grilling device. Otherwise, the fat might get into contact with the food to be cooked which is laid upon the grilling device.

It is to be understood that the grilling device is made of a heat-resistant material or a composition of such materials, and is preferably provided at least at its top side with an anti-friction coating.

To simplify the description, distinction is explicitly made between raised portions and depressions on the top side of the inset, although it will be understood that when one provides raised portions, then depressions will automatically arise between the raised portions.

Preferably, the top side is configured such that fluids can flow off from the top side into the cooking appliance. This guarantees that the underside of the food always remains almost “dry”, even when considerable fluid drippings arise.

In a further preferred embodiment, the grilling device comprises at least one discharge hole running from the top side to the underside. Although it is normally sufficient when the fluid can flow off from the edge of the grilling device, the provision of such discharge hole promotes the aim of keeping the underside of the food dry.

It is particularly preferred when the hole is arranged in the region of a depression. The fluid, thereby, can easily flow out of the depression into the hole.

Further, it is preferred when the grilling device comprises at least one flattened portion at the edge. With this, the grilling device can be more easily grasped by hand or with an utensil. This is particularly the case when the grilling device, when seen from the top, has approximately the shape of a circle and when the outer diameter of the grilling device is substantially the same as the inner diameter of the frying device.

In a further preferred embodiment, the top side comprises a plurality of adjacent troughs. The liquid arising from the food can be uniformly distributed in the troughs. With the troughs being arranged to lie adjacent to one another, the raised portions lying therebetween are formed substantially in the shape of ribs. This leads to an aesthetically pleasing pattern being formed on the grilled food.

Preferably, the troughs run from edge to edge and are at least approximately parallel. This results in a substantially straight line configuration of the troughs, whereby flow resistance is small. The liquid can flow more easily.

Preferably, the troughs are inclined with respect to the underside towards one edge. Elongated flow channels result with low flow resistance.

In an alternative embodiment, the parallel troughs are inclined with respect to the underside from about their center towards two edges in opposite direction. The “individual troughs” of constant slope are shorter, so that with a given inclination angle, the grilling device can be made flatter on the whole. It will be understood that the slope can fall off towards the edge or can be configured to rise towards the edge. In the latter case, it is preferred that at least one hole be provided in the region of the central transverse axis (i.e. the middle of the parallel troughs) connecting to the underside for discharge of liquid and/or a cross-trough.

In a further alternative embodiment, the troughs run approximately from a center point radially outwardly to the edge. This achieves an aesthetically pleasing pattern. The troughs are equally long so that a uniform fluid flow is ensured.

In a particularly preferred embodiment, the troughs are inclined with respect to the underside, starting from the center point running to the edge. The flow of fluid in the trough is promoted. It will be understood that the slope can fall off towards the edge, so that the fluid flows off the edge of the grilling device. On the other hand, however, a central hole or a central recess can be provided such that the fried food or grilled food remains dry at its underside.

In a further preferred embodiment, the top side is generally subdivided in a number of sectors and the troughs within each sector run approximately parallel to a sector bisectrix. This provides a particularly advantageous trough pattern. In addition, the troughs can be comparatively short.

Preferably, the troughs are inclined with respect to the underside, starting from their boundary to a neighboring sector towards the edge. When flow is provided towards the edge, a continuous transition from interconnected troughs results at the sector boundaries. If the slope is formed to rise towards the edge, cross troughs are preferably provided at the sector boundaries.

In a further preferred embodiment, the troughs are formed to be generally wave-shaped. A particularly unique appearance results; the grilling device is easily distinguished from other kitchen appliances.

The inclination angle of the trough or troughs is preferably between 0.5° and 10°, more preferably between 0.5° and 2°. It has been found that such inclination angles, measured with respect to the horizontal, can achieve a good flow-off of the fluid in the troughs, and at the same time the height of the grilling device on the whole is still acceptable (without upstanding edge).

Preferably, the depth of the troughs over the length of the troughs in flow-off direction is constant. Due to the constant depth of the troughs, heat can be transferred uniformly onto the food to be cooked.

In an alternative embodiment, the depth of the troughs over the length of the troughs in flow-off direction continuously increases. In this manner, the raised portions or ribs between the troughs can be substantially horizontal. In addition, the troughs can carry an increasing amount of fluid in flow-off direction, similar to a river bed.

In accordance with the second aspect of the invention, it is, as described above, generally possible to design the top side of the grilling device such that fluid can flow off therefrom. Particularly, when the grilling device is formed to be a substantially flat plate or disc, respectively, the top side can be formed correspondingly. It is to be understood that such design generally allows to use the grilling device on a common heating place like a charcoal grill. However, it is preferred that the grilling device of this embodiment is used in combination with a cooking device, particularly a frying pan, wherein fluid which flows off from the top side of the grilling device is collected within the cooking device.

In accordance with the above-mentioned first aspect of the invention, however, the grilling device includes a cross-trough which is provided at the top side and serves as a collection container. The depressions on the top side of the grilling device do already receive fluid. A collection container, however, is to be understood in a sense that it can take up the entire or a large portion of the fluid resulting from a grilling process of a typical food such as a beef fillet steak. Thus, there will be no “juice accumulation” within the troughs. Further, it can be prevented that the resulting fluid flows off into the frying pan and possibly mixes there with hot fat, which as is well-known, can lead to the fat being sprayed or splattered. If the grilling device is used without fat or with only little fat in the frying pan, it is also possible to remove the grilling device from the frying pan after grilling and to serve it on a dinner table.

However, the grilling device according to the first aspect of the invention cannot only be used in combination with a cooking appliance like a frying pan, due to the collection container. On the contrary, the grilling device can be placed directly on a common cooking place like a heating plate, a charcoal grill, etc. The collection container prevents that fluid drops from the top side of the grilling device onto the cooking place. It is to be understood that the collection container is preferably integrated into the surface structure of the grilling device.

Further, it is preferred when the cross-trough is provided at an edge of the grilling device.

In this manner, the central region of the surface of the grilling device can be provided with continuous troughs and ribs lying therebetween, so that a large, central uniform surface results for the food to be fried or grilled.

It is also preferred that the grilling device be substantially circular. This shape is compatible with most other cooking appliances as well as with the shape of heating places. As far as the grilling device is used in combination with a cooking device, the circular shape can be placed within most pots and pans.

It is particularly preferred that the cross-trough has essentially the shape of a crescent, when seen from the top.

On the one hand, this provides that each of the troughs distributed over the area of the top side can flow into the cross-trough. On the other hand, the contact area for the food to be fried is maximized. Finally, an aesthetically pleasing shape is provided.

Instead of the shape of a crescent, it is also possible to provide the cross-trough as an annular depression which extends around the circumference of the grilling device, and into which each of the troughs leads.

The raised portions preferably have a height with respect to the depressions in a range of between 2 mm and 12 mm, more preferably between 3 mm and 8 mm. It has been found that such values are particularly favorable (with varying height, the values represent average values). A good compromise is achieved between the volumetric capacity of the troughs on the one hand and the height of the grilling device on the other hand.

The grilling device is preferably formed as a solid element made of heat-conducting, heat-resistant material. Aluminum alloys for example are suitable as the material, which is also known for frying pans. Preferably, the element is formed integrally, for example formed by casting. In addition, at least the top side of the grilling device can be provided with an anti-friction coating as is known per se.

In a particularly preferred embodiment, the grilling device comprises an upstanding edge.

With this feature, the inventive grilling device can be used in an even more versatile manner.

On the one hand, a lid can be placed as is well-known on an upstanding edge. Thus, the grilling device is also suitable for stewing. Further, the upstanding edge prevents that fluid drops off from the grilling device if large amounts of fluid lead to an overflow of the collection container. Thus, the grilling device can be used safely on heating places, on charcoal grills, etc.

It is also preferred when the grilling device comprises a grip.

The grilling device, in a whole, can be more easily handled with such a grip or handle.

It is particularly preferred when the upstanding edge comprises a mount for fixing a detachable grip.

Thereby, the grilling device can be used in an even more versatile manner. For instance, on a charcoal grill, a grip is generally not desired. On the other hand, on common heating plates, a grip is generally advantageous for fast handling.

In a further preferred embodiment, the grilling device comprises a plurality of support noses which are preferably provided within the upstanding edge, for supporting a hood.

The support noses serve preferably for supporting a glass hood as is known as a part of the above-discussed cover (DE 35 05 630 C1).

It is particularly preferred when the support noses are arranged such that an air gap remains between an outer edge of the glass hood and an inner edge of the grilling device. Frying steam can draw away via the opening in the glass hood. Thus, fresh air can be “sucked” in via the air gap so that the food to be fried does not simmer in its own steam but can be crisply fried. The glass hood prevents the splattering of fat.

In case that the grilling device is provided without upstanding edge, it is formed to be substantially flat and preferably does not provide any handles, grips or the like.

Preferably, the grilling device has a height in the range of between 3 mm and 15 mm, more preferably between 5 mm and 12 mm. In case that an upstanding edge is provided, this preferred range of height applies for the floor of the grilling device. It has been found that this height on the whole provides a good compromise between good heat transfer to the food and a good transport of fluid away from the food.

Further advantages and features of the present invention can be taken from the following description of the figures. It will be understood that the above mentioned features and those to be discussed below are applicable not only in the given combinations, but may be used in other combinations or taken alone without departing from the scope of the present invention.

Embodiments of the invention are illustrated in the drawings and will be described in detail below:

### BRIEF DESCRIPTION OF THE DRAWINGS

FIG. 1 shows a plan view of a first embodiment of the grilling device according to the second aspect of the invention;

FIG. 2 shows a cross-section along the line II-II of FIG. 1;

FIG. 3 shows a cut-out portion III of FIG. 1;

FIG. 4 shows a cross-section along the line IV-IV in FIG. 3;

FIG. 5 shows a view similar to FIG. 4 of an alternative embodiment of the grilling device according to the present invention;

FIGS. 6 to 8 show schematic top views of alternative embodiments of grilling devices according to the present invention;

FIG. 9 shows a plan view of an embodiment of a grilling device according to the first aspect of the present invention;

FIG. 10 shows a cross-section along the line X-X in FIG. 9;

FIG. 10a shows a cross-section similar to FIG. 10 of an alternative embodiment of a grilling device according to the present invention, with discharge holes;

FIG. 11 shows a cross-section of another embodiment of a grilling device according to the first aspect of the invention;

FIG. 12 shows a view similar to FIG. 11 of a further embodiment of a grilling device according to the first aspect of the invention;

FIG. 13 shows a cross-section similar to FIG. 11 of a further embodiment of a grilling device according to the first aspect of the invention.

FIG. 14 shows a cross-section similar to FIG. 11 of still a further embodiment of a grilling device according to the first aspect of the present invention;

FIG. 15 shows a plan view of the embodiment of FIG. 14;

FIG. 16 shows a detachable grip for use with the embodiment of FIG. 14;

FIG. 17 shows a view of the embodiment of FIG. 14 in combination with a lid; and

FIG. 18 shows a view of the embodiment of FIG. 14 in combination with a glass hood.

### DETAILED DESCRIPTION OF THE PREFERRED EMBODIMENTS

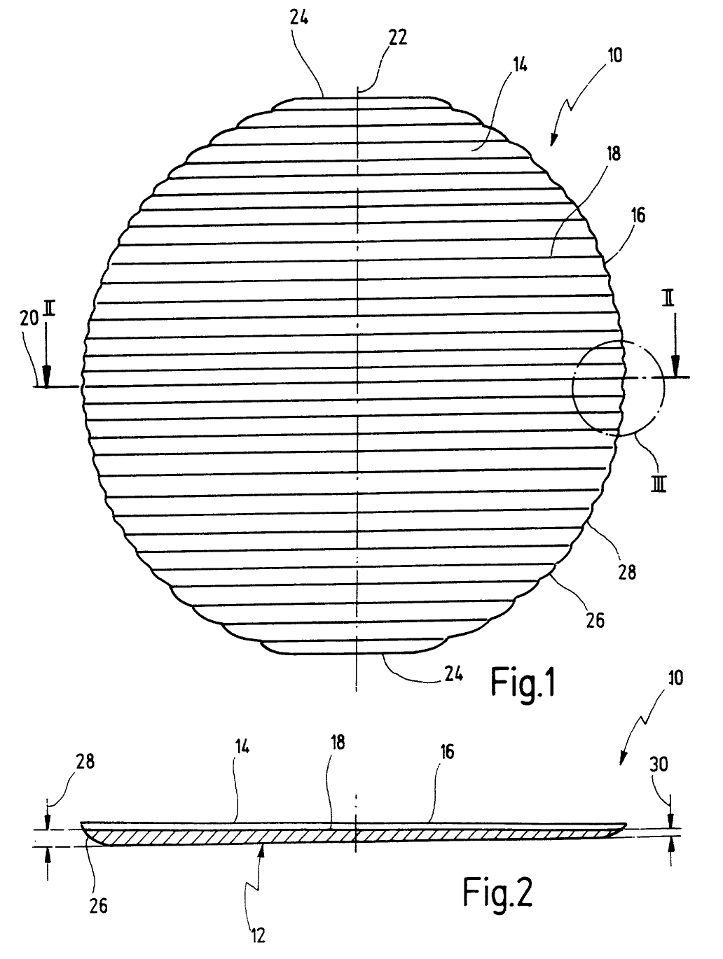

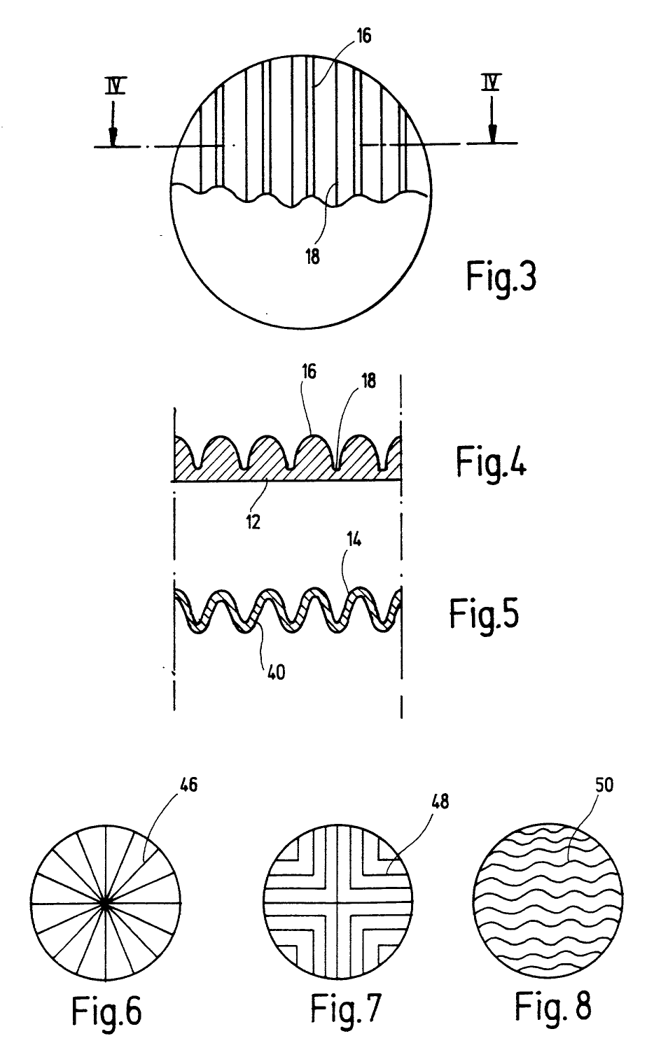

A first embodiment of the grilling device according to the second aspect of the invention is shown in FIGS. 1 to 4 and generally designated with the numeral 10. The grilling device 10 is particularly useful in combination with a cooking or frying appliance like a frying pan.

The grilling device 10 generally has the form of a circular disc and comprises a flat underside 12 and a top side 14.

A plurality of raised portions 16 running parallel to one another are provided on the top side 14 in the form of ribs, between which corresponding depressions 18 are formed as troughs. The direction of the ribs 16 and the troughs 18, respectively, define a longitudinal axis 20 which passes through the center point of the circular-disc shaped grilling device 10.

At the edge of the grilling device 10, namely where an axis 22 running transversely to the longitudinal axis 20 intersects the edges, a partial segment of the grilling device is removed, so that flattened portions 24 are located in these regions.

The circular surface of the underside 12 is a little smaller than the circular surface of the top side 14 and the edge 26 is beveled where the underside 12 joins the top side 14. The underside 12 is thus adapted to the floor of frying appliances such as frying pans, with the generally pan-shaped configuration.

Due to the beveling, the edge 26 of the grilling device 10 appears to be wave-like in the plan view of FIG. 1, which is due to the fact that the ribs 16 and the troughs 18 are cut at an angle. Thus, the grilling device 10 can also be placed in frying appliances whose inner diameter is about the same as the outer diameter of the grilling device 10. The beveled edge 26 adapts itself at the underside 12 to the typical form of the floor of the frying appliance. The grilling device 10 can be comparatively easily removed from the frying device due to the flattened portions 24.

The ribs 16 and the troughs 18 have a wave-structure in cross-section as shown schematically in FIG. 4, which e.g. can have a curve approximating a sine function, as indicated schematically in FIG. 4. Naturally, the upper side of the ribs 16 can also be flattened. The ribs 16 and the troughs 18 can also have corners, so that the illustrations in FIG. 4 could represent a triangle function, a saw-tooth function, a rectangular function, a trapezoidal function, etc.

As best seen in FIG. 2, the troughs 18 are inclined with respect to the underside 12, so that the troughs 18 form an angle of about 1° with the underside 12. Consequently, the troughs 18 have a greater height 28 with respect to the underside 12 at one edge than in the region of the opposing edge. In FIG. 2, the height at the opposing edge is indicated with the numeral 30.

The grilling device 10 is formed integrally of an aluminum casting material and is provided with an anti-friction coating on its surface in a manner known per se.

In use, the frying appliance, normally a frying pan, is initially heated on a cooking place. Thereafter, fat is placed in the pan and then the grilling device 10 is placed on the floor of the frying appliance. The level of the fat is below the top side 14.

Good heat transfer is achieved from the floor of the frying appliance to the top side 14 of the grilling device due to the flat underside 12. The material of the grilling device 10 has particularly good heat conduction and heat resistance properties.

The fat in the pan promotes heat transfer from the floor of the frying pan to the grilling device 10, particularly when the floor of the pan is not completely flat.

As soon as the grilling device 10 is sufficiently heated, in particular at its top side 14, the food to be roasted or grilled is placed on the grilling device 10. The food is cooked through contact with the ribs 16 and through radiation heat from the troughs 18. The fluid or drippings exuding from the food is collected in the troughs 18 and flows to the edge 26 of the grilling device 10 promoted by the slope of the troughs 18 and components of gravity. The fluid flows from the grilling device 10 to the floor of the frying appliance in the region of the edge 26.

Due to the fluid flow, it is ensured that even when a large amount of fluid arises, the underside of the food remains “dry”. The food thus does not begin to simmer in its own drippings. In this manner, a type of cooking is achieved which is comparable to grilling. In addition, the food does not come into contact with the fat in the frying appliance so that it retains its own taste. It will be understood that the fat in the frying pan need not be of high quality and taste, but should be heatable to a great extent without the development of smoke.

Even if the grilling device 10 is placed in a frying appliance having an inner diameter corresponding to the outer diameter of the grilling device 10, the fluid can flow out of the troughs 18 because the edge 26 does not sit flush with the inner wall of the frying appliance due to its wave-like structure in the region of the troughs 18.

The slope of the troughs 18 is 1°, as mentioned, however, it can also be somewhat smaller or larger. Preferably, the slope of the troughs with respect to the plane of the underside 12 is between 0.5° and 10°, more preferably between 0.5° and 2°. The depth of the troughs 18 is approximately constant over their entire length. Consequently, the top side 14 of the grilling device 10 on the whole is inclined, because the ribs 16 also slope towards the edge with a corresponding inclination. The ribs 16 have a height with respect to the troughs 18 in the range of about 5 mm, however, the height can be generally in the range of between 2 mm and 12 mm, more preferably between 3 mm and 8 mm.

FIG. 5 shows an alternative embodiment of the grilling device, whose top side 14 can be configured to be identical with the top side 14 of the grilling device 10 in FIGS. 1 to 4. The grilling device in FIG. 5 is not made of a solid casting, but preferably of refined steel sheet or aluminum sheet material which has been bent to form the top side 18. Thus, the underside 40 of the grilling device is also correspondingly bent.

This grilling device is less expensive to manufacture, however, does not have the same good heat transfer properties on cooking stoves as does the grilling device 10 with the flat underside 12. This alternative grilling device is not in accordance with the second aspect of the invention but is useful in particular in combination with the first aspect of the invention, as is described in the following. As an example, it is possible to manufacture a drip pan according to the second aspect of the invention.

FIGS. 6 to 8 show alternative embodiments of the grilling device in schematic plan view. In FIG. 6, the grilling device comprises radial troughs 46 extending from the center point of the circular disc. The grilling device of FIG. 7 is subdivided into four sectors. In each sector, the troughs 48 run approximately parallel to a bisectrix. On the whole, a cross-like configuration results, when seen in plan view. FIG. 8 shows a plan view of a grilling device having wave-like troughs 50.

The grilling devices of FIGS. 1 to 8 can have level troughs or can be configured with sloped troughs. It will be understood that the troughs 46, 48 in FIGS. 6 and 7 preferably are configured to slope downwardly towards the edge. However, it is possible to provide a rising slope towards the edge. In this case, a reservoir and/or a drain hole to the underside of the grilling device must be provided in approximately the center of the respective grilling device.

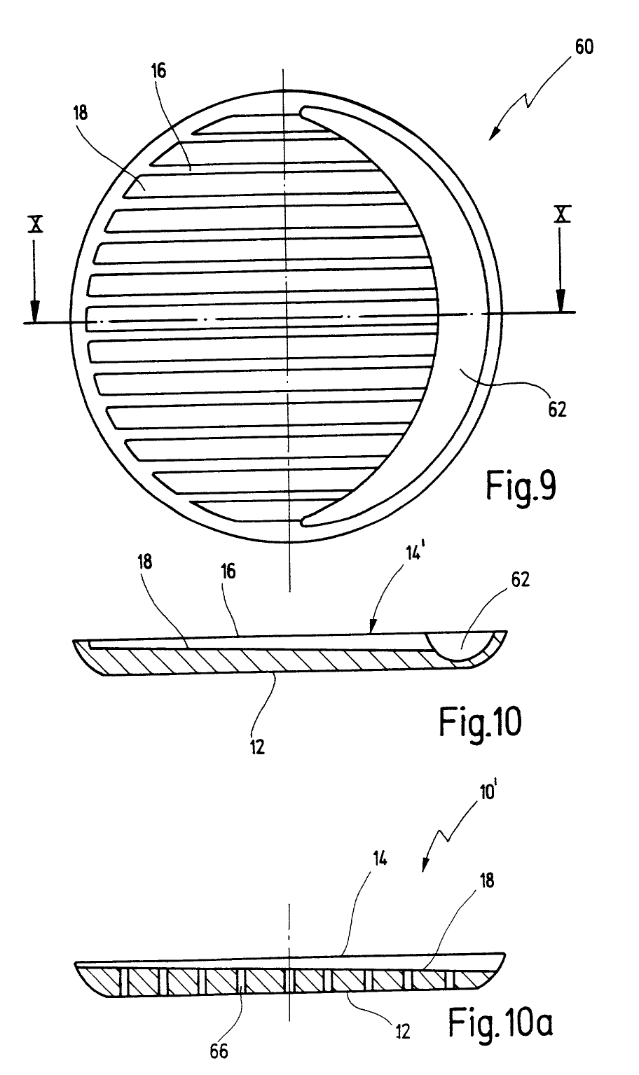

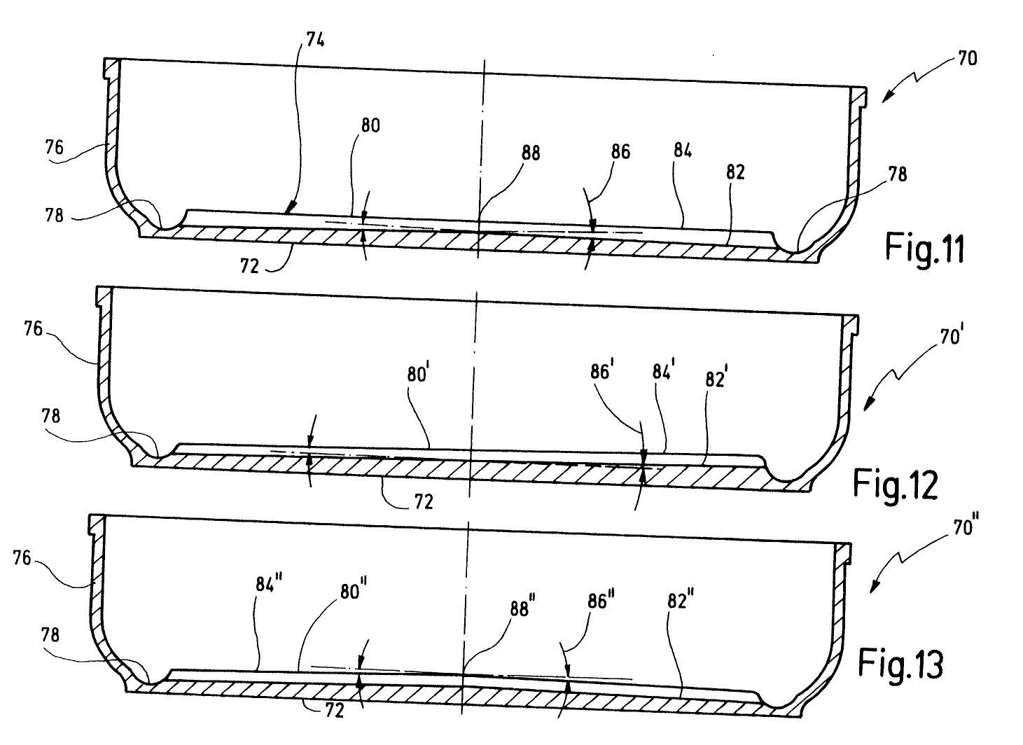

A further embodiment of a grilling device 60 according to the first and the second aspect of the invention is shown in FIGS. 9 and 10.

The grilling device 60 also comprises a flat underside 12 and a top side 14 with troughs 18 and ribs 16 extending from one edge to the other.

In contrast to the grilling device 10 of FIGS. 1 to 4, the troughs 18 empty into a crescent-shaped reservoir 62 provided in the upper surface 14. The reservoir 62 is provided at the edge of the grilling device 60 and has a well shape in cross-section.

Fluid exuding from the food initially flows into the troughs 18 and from there into the reservoir 62 with the aid of the slope of the troughs 18. It is thus prevented that the fluid from the food reaches the floor of the frying appliance in which the grilling device 60 is placed. Sprayed fat can be avoided, assuming that fat has been provided in the frying appliance during the grilling process. When the bottom of the appliance is dry, it is possible to remove the grilling device 60 from the appliance after grilling together with the roasted or grilled food and to thereby serve the food on the grilling device 60.

FIG. 10a shows an alternative embodiment of the grilling device in accordance with the second aspect of the present invention, which is similarly configured to the grilling device 10 of FIGS. 1 to 4.

However, the grilling device shown in FIG. 10a comprises a plurality of drain holes, which extend from the troughs 18 to the underside 12. Fluid arising in the troughs 18 then does not necessarily flow to the edge of the grilling device, but can be directly lead off via the drain holes 66.

It will be understood that a reservoir is not necessary in this embodiment. Further, a single central drain hole can be provided at the center of the corresponding grilling device when the troughs are provided in a more point-symmetrical arrangement as the troughs 46, 48 in FIGS. 6 and 7.

FIGS. 11 to 13 show different embodiments of grilling devices according to the first and the second aspect of the present invention in longitudinal cross-section wherein the grilling devices each comprise an upstanding edge. In general, the shape of a frying pan is established due to the upstanding edge even though a grip is not necessarily provided.

The grilling device shown in FIG. 11 is provided in the form of a frying pan and is designated with the numeral 70.

The frying pan 70 comprises an underside 72 for placement on a cooking place, a floor 74 for placement of the foodstuff and an upstanding circumferential edge 76. The material and/or the coating can be similar to that for the grilling device 10.

Further, the frying pan 70 is preferably provided with a grip and/or one or two handles (not shown).

A reservoir 78 in the form of an annular trough is formed in the floor 74 adjacent to the upstanding edge 76.

An upper side 80 of the floor 74 is provided with a plurality of longitudinal troughs 82 radially inward of the reservoir 78, where FIG. 11 shows one such trough in cross-ection. In the plan view, the top side 80 has a comparable form to the top side 14 of the grilling device 10 of FIGS. 1 to 4. It will be understood that the approximately parallel troughs 82 are separated by corresponding ribs 84.

In contrast to the troughs 18 of the grilling device 10, the troughs 82 are sloped with respect to the underside 72 in opposing directions starting from the center 88 and going outwards to the two opposing edges. In other words, the highest point of the trough 82 is at the center or center axis 88 of the frying pan 70. The ribs 84, however, are arranged such that their top sides run parallel with the underside 72 of the frying pan 70. Consequently, the depth of the troughs 82 increases towards the edge, i.e. towards the reservoir 78. The inclination angle 86 of the troughs 82 in this embodiment is about 2°.

Consequently, the frying pan 70 is a grilling pan with which food placed on the top side 80 can be heated while maintaining its underside substantially dry, because the liquids dripping from the food flow through the troughs 82 into the reservoir 78.

A modified embodiment of a grilling device in accordance with the present invention in the shape of a frying pan 70′ is shown in FIG. 12.

The difference to the pan of FIG. 11 is that the parallel troughs 82′ run from one edge on the top side 80′ continuously to the other edge with the same inclination angle 86′, which in this embodiment is 1°. One recognizes that the top side 80′ formed within the interior of the reservoir 78′ of the frying pan 70′ is substantially identical to the top side 14 of the grilling device 10 of FIGS. 1 to 4.

A further modification of a grilling device according to the present invention in the shape of a frying pan 70′ is shown in FIG. 13. The frying pan 70″ is generally identical to the structure of the frying pan 70 of FIG. 11. However, the ribs 84″ are not parallel to the underside 72, but are parallel to the slope of the troughs 82″. Consequently, the top side 80″ in this embodiment is not level but comprises a type of ridge in the area of the transverse axis (not shown), which runs perpendicular to the surface of the paper in FIG. 13. In this respect, it is also mentioned that the top side 80′ of FIG. 12 is inclined to one side, similar to a sloped roof, because the ribs 84′ are aligned to be parallel with the troughs 82′. Alternatively, in the embodiment of FIG. 12, the ribs 84′ could be arranged to be parallel to the underside 72, where the depth of the troughs 82′ would then increase in fluid flow direction.

It will be understood that flat grilling devices, such as the grilling devices 10 and 60 of FIGS. 1 to 10, can be provided with top sides which are identical or similar to those of the frying pans 70, 70′ and 70″ shown in FIGS. 11 to 13.

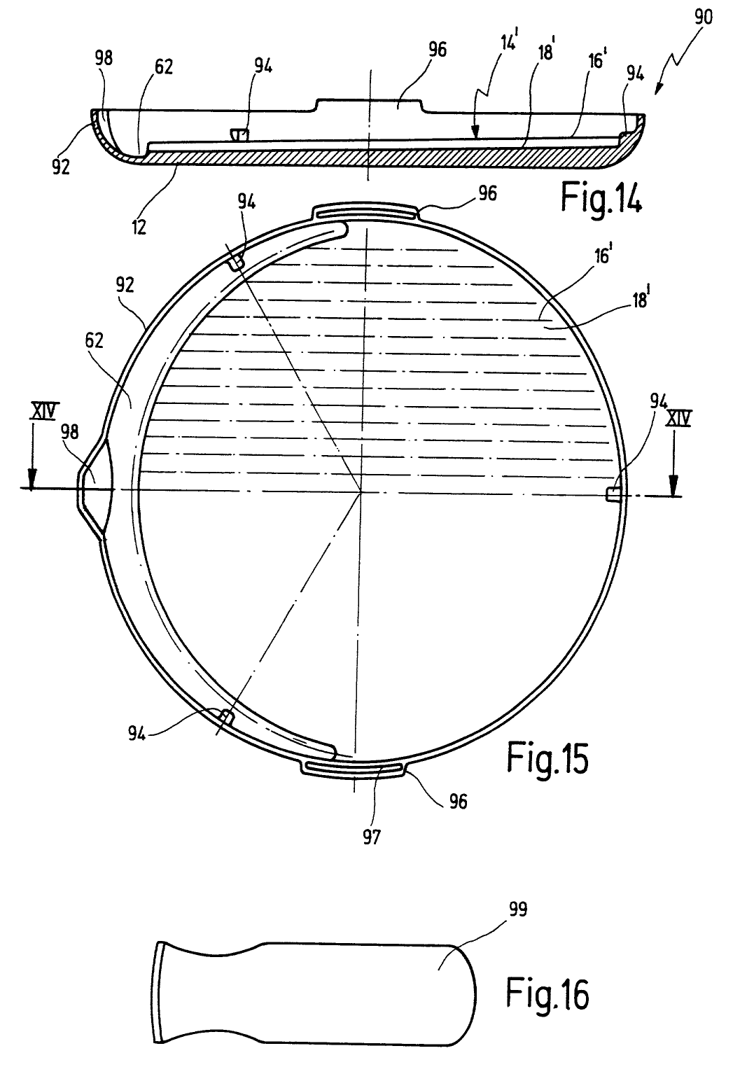

A further embodiment of a grilling device according to the first and second aspect of the present invention in the shape of a frying pan 90 is shown in FIGS. 14 and 15.

The frying pan 90 comprises a flat underside 12 and a top side 14′ as well as an upstanding edge 92.

In contrast to the upstanding edges 76 of the frying pans 70 of FIGS. 11 to 13, the upstanding edge 92 is not formed to be substantially vertical but runs from the underside 12 like the shape of a well to the upper border of the upstanding edge 92.

The top side 14′ of the frying pan 90 is provided with parallel ribs 16′ and troughs 18′. The depth of the troughs 18 is constant from one end to the other. The troughs 18′ are further sloped continuously towards one side. Consequently, the top side 14′ of the frying pan 90 on the whole is sloped.

The troughs 18′ empty into a crescent-shaped reservoir 62 which extends within the upstanding edge 92 approximately over an angle of 180°.

Further, three support noses 94 are provided within the upstanding edge 92 and are distributed equidistantly around the circumference of the frying pan 90. Each of the support noses 94 extends a small distance from the upstanding edge 92 towards the inside. Two of the support noses 94 are provided in the region of the reservoir 62.

At the outer side of the upstanding edge 92, two grip holders 96 are provided and displaced from each other by 180°. The grip holders 96 are each arranged approximately in the region of the ends of the reservoir 62. Each grip holder 96 comprises a longitudinal hole 97.

The upstanding edge 92 is provided with a bulge 98 projecting outwardly at a central region of the reservoir 62. On the one hand, the bulge serves to receive a grip of a glass hood as will be explained below. On the other hand, fluid can be poured in a well-aimed manner and without drippings from the reservoir 62 due to the bulge 98.

FIG. 16 is a schematic view of a grip 99 which can be inserted into the hole 97 in order to handle the frying pan 90 more easily. The holes 97 can also serve to hang the frying pan 90.

The inner diameter of the upstanding edge 92 corresponds in the region of its upper border to the standard diameter of pots, frying pans, etc.

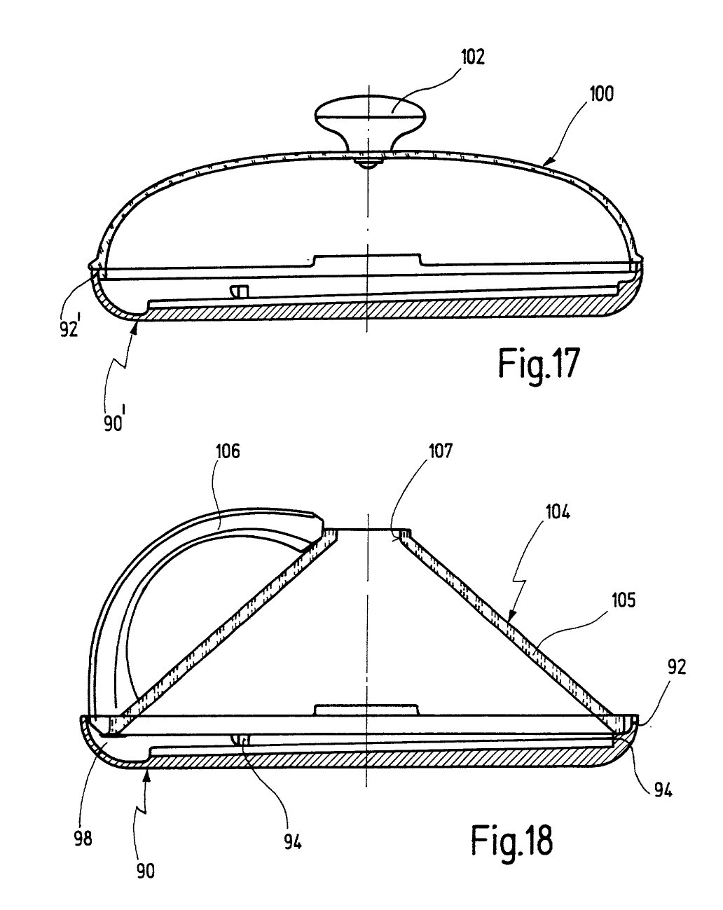

Thus, a lid 100 can be placed onto the upper border of the upstanding edge 92, as is shown in FIG. 17. The lid 100 shown in FIG. 17 is a glass lid with a lid grip 102.

The frying pan 90′ shown in FIG. 17 is modified with respect to the frying pan 90 of FIGS. 14 and 15 insofar as it does not comprise a bulge 98. Thus, the upstanding edge is generally designated with numeral 92′ in FIG. 17. It will be understood, however, that a lid such as the lid 100 can also be placed upon the frying pan 90 of FIGS. 14 and 15, even if in this case an opening remains via the bulge 98.

FIG. 18 shows a situation where a glass hood 104 is placed into the frying pan 90 of FIGS. 14 and 15. The glass hood 104 comprises a conically shaped glass part 105 which has an upper opening 107 as well as a hood grip 106 attached to an outer portion of the glass part 105. The hood grip 106, at one end, reaches into the opening 107, and, at the other end, around a lower edge of the glass part 105.

The diameter of the lower edge of the glass part 105 is sized such that the hood 104 on the whole can be placed within the upstanding edge 92 onto the support noses 94. The lower part of the hood grip 106 is received within the bulge 98.

As can be seen in FIG. 18, the outer diameter of the glass part 105 does not abut against the inner side of the upstanding edge 92. Thus, an air gap remains between the inner side of the upstanding edge 92 and the outer border of the glass part 105, allowing an exchange of air.

The frying pan 90 is useful in a most versatile manner. On the one hand, it can be placed onto any cooking places like charcoal or gas grills, due to its plane underside. On the other hand, it is, due to the pan-shaped design of the upstanding edge 92, possible to place the frying pan 90 as a grilling device into another frying pan or into a cooking pot. This type of use is explained in detail with reference to the embodiment of FIGS. 1 to 4.

Fluid exuding from the food to be fried flows within the troughs 18 into the reservoir 62, due to the shape of the top side 14′. Thus, the foodstuff can be cooked, wherein it remains dry at its underside. If it is desired to stew food, a lid 100 can be placed onto the upstanding edge 92, 92′. If it is merely desired to avoid fat to be sprayed, but stewing of the top side of the food is to be avoided, a hood 104 can be placed onto the support noses 94. During such use, fat spray is captured by means of the glass part 105 and does not reach the cooking place. Steam that is produced during grilling, can escape via opening 107. Fresh air can be sucked in via the air gap between the upstanding edge 92 and the glass part 105 so that a type of “chimney effect” is produced. Conclusively, it can be prevented at any time that an accumulation of steam occurs within the hood 104, due to which the top side of the food could be stewed.

When using the frying pan 90 on a cooking stove, it can be easily handled due to the detachable grip 99. When using the frying pan 90 on a charcoal or gas gill, the grip 99 is preferably detached. Due to the heat radiation, the grip 99 would be heated to the same extent as the frying pan 90 itself. Before removing the frying pan 90 from the charcoal grill, the grip 99 can subsequently be re-attached.

Fluid that has been collected within the reservoir 62 during a frying or a grilling process can easily be poured out of the pan by means of the bulge 98. The frying pan 90 can be manufactured at comparatively low costs, because the frying pan 90 is provided as an integral device (apart from the optional grip 99). The casting mold can be made simple because no undercuttings or the like are provided. Further, the inventive grilling device, which is termed frying pan in some embodiments, can be easily cleaned.

What we claim is:

1. A grilling device for a cooking appliance, with an underside and a top side upon which a foodstuff to be cooked can be laid, wherein the top side comprises a plurality of raised portions upon which the foodstuff can be laid and a plurality of depressions in which liquid can be received,
wherein at least some of the depressions are troughs which are inclined with respect to the underside, and wherein a cross-trough is provided at the top side, serving as a collection container into which the troughs lead.

2. The grilling device of claim 1, wherein the top side comprises a plurality of adjacent troughs.

3. The grilling device of claim 2, wherein the troughs run from edge to edge and are at least approximately parallel.

4. The grilling device of claim 3, wherein the troughs are inclined with respect to the underside towards one edge.

5. The grilling device of claim 3, wherein the troughs are inclined with respect to the underside from about their center towards two edges in opposite direction.

6. The grilling device of claim 2, wherein the troughs run approximately from a center point radially outwardly to the edge.

7. The grilling device of claim 6, wherein the troughs are inclined with respect to the underside, starting from the center point running to the edge.

8. The grilling device of claim 2, wherein the top side is generally subdivided in a number of sectors and the troughs within each sector run approximately parallel to a sector bisectrix.

9. The grilling device of claim 8, wherein the troughs are inclined with respect to the underside, starting from their boundary to a neighboring sector towards the edge.

10. The grilling device of claim 2, wherein the troughs are formed to be generally wave-shaped.

11. The grilling device of claim 1, wherein the inclination angle of the troughs is preferably between 0.5° and 10°, more preferably between 0.5° and 2°.

12. The grilling device of claim 1, wherein the depth of the troughs over the length of the troughs in flow-off direction is constant.

13. The grilling device of claim 1, wherein the cross-trough is provided at an edge of the grilling device.

14. The grilling device of claim 1, wherein the grilling device is substantially circular in plan view.

15. The grilling device of claim 1, wherein the cross-trough is provided at an edge of the grilling device, wherein the grilling device is substantially circular in plan view, and wherein the cross-trough has essentially the shape of a crescent, when seen from the top.

16. The grilling device of claim 1, wherein the raised portions have a height with respect to the depressions in a range of between 2 mm and 12 mm, more preferably between 3 mm and 8 mm.

17. The grilling device of claims 1, wherein the grilling device is formed as a solid element made of heat-conducting, heat-resistant material.

18. The grilling device of claim 1, further comprising an upstanding edge.

19. The grilling device of claim 1, further comprising a grip.

20. The grilling device of claim 1, further comprising an upstanding edge and a detachable grip, wherein the upstanding edge comprises a mount for fixing said detachable grip.

21. The grilling device of claim 1, further comprising a plurality of support noses which are preferably provided within the upstanding edge, for supporting a hood.

22. The grilling device of claim 1, where in the underside of the grilling device is formed to be substantially flat.

23. The grilling device of claim 22, wherein the top side is configured such that fluids can flow off from the top side into the cooking appliance.

24. The grilling device of claim 23, wherein the grilling device comprises at least one discharge hole running from the top side to the underside.

25. The grilling device of claim 23, wherein the grilling device comprises at least one flattened portion at the edge.

26. A grilling device for a cooking appliance, wherein the grilling device comprises an underside and a top side upon which a foodstuff to be cooked can be laid, wherein the top side comprises a plurality of raised portions upon which the foodstuff can be laid and a plurality of depressions in which liquid can be received, and wherein the underside of the grilling device is formed to be substantially flat.

27. The grilling device of claim 26, wherein the top side is configured such that fluids can flow off from the top side into the cooking appliance.

28. The grilling device of claim 27, wherein the grilling device comprises at least one discharge hole running from the top side to the underside.

29. The grilling device of claim 27, wherein the grilling device comprises at least one flattened portion at the edge.

30. The grilling device of claim 26, wherein the top side comprises a plurality of adjacent troughs.

31. The grilling device of claim 30, wherein the troughs run from edge to edge and are at least approximately parallel.

32. The grilling device of claim 31, wherein the troughs are inclined with respect to the underside towards one edge.

33. The grilling device of claim 31, wherein the troughs are inclined with respect to the underside from about their center towards two edges in opposite direction.

34. The grilling device of claim 30, wherein the troughs run approximately from a center point radially outwardly to the edge.

35. The grilling device of claim 34, wherein the troughs are inclined with respect to the underside, starting from the center point running to the edge.

36. The grilling device of claim 30, wherein the top side is generally subdivided in a number of sectors and the troughs within each sector run approximately parallel to a sector bisectrix.

37. The grilling device of claim 36, wherein the troughs are inclined with respect to the underside, starting from their boundary to a neighboring sector towards the edge.

38. The grilling device of claim 30, wherein the troughs are formed to be generally wave-shaped.

39. The grilling device of claim 30, wherein the inclination angle of the trough or troughs is preferably between 0.5° and 10°, more preferably between 0.5° and 2°.

40. The grilling device of claim 30, wherein the depth of the troughs over the length of the troughs in flow-off direction is constant.

41. The grilling device of claim 30, wherein a cross-trough is provided at the top side, serving as a collection container into which the troughs lead, said cross-trough being provided at an edge of the grilling device.

42. The grilling device of claim 26, wherein the grilling device is substantially circular in plan view.

43. The grilling device of claim 41, wherein the grilling device is substantially circular in plan view and wherein the cross-trough has essentially the shape of a crescent, when seen from the top.

44. The grilling device of claim 26, wherein the raised portions have a height with respect to the depressions in a range of between 2 mm and 12 mm, more preferably between 3 mm and 8 mm.

45. The grilling device of claim 26, wherein the grilling device is formed as a solid element made of heat-conducting, heat-resistant material.

46. The grilling device of claim 26, further comprising an upstanding edge.

47. The grilling device of claim 26, further comprising a grip.

48. The grilling device of claim 26, further comprising an upstanding edge and a detachable grip, wherein the upstanding edge comprises a mount for fixing said detachable grip.

49. The grilling device of claim 26, further comprising a plurality of support noses which are preferably provided within the upstanding edge, for supporting a hood.
